(19) United States
(12) Patent Application Publication
(10) Pub. No.: US 2010/0070691 A1
(43) Pub. Date: Mar. 18, 2010

(54) Multiprocessor system having multiport semiconductor memory device and nonvolatile memory with shared bus

(75) Inventor: Jin-Hyoung Kwon, Seongnam-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/585,535

(22) Filed: Sep. 17, 2009

(30) Foreign Application Priority Data
Sep. 18, 2008 (KR) 10-2008-0091419

(51) Int. Cl. G06F 12/02; G06F 12/00

(52) U.S. Cl. 711/103; 711/149; 711/E12.001; 711/E12.008

(57) ABSTRACT

A multiprocessor system employing a multiport semiconductor memory device and a nonvolatile memory having a shared bus is provided. The multiprocessor system includes a first processor; a second processor; a semiconductor memory device including a shared memory area accessed in common by the first and second processors through different ports and assigned within a memory cell array, and an internal register positioned outside the memory cell array, the internal register being configured to provide an access authority for a shared bus to the first and second processors; and a nonvolatile semiconductor memory device having first and second nonvolatile memory areas coupled corresponding to the first and second processors through the shared bus, the first and second nonvolatile memory areas being accessed by and corresponding to the first and second processors according to the access authority for the shared bus.

### CROSS-REFERENCE TO RELATED APPLICATIONS

This application claims priority under 35 U.S.C. §119 to Korean Patent Application No. 10-2008-0091419, filed on Sep. 18, 2008, in the Korean Intellectual Property Office (KIPO), the entire contents of which are incorporated herein by reference.

### BACKGROUND

The inventive concept relates to a multiprocessor system, and more particularly, to a multiprocessor system employing a nonvolatile memory and a multiport semiconductor memory device.

Today there exists marked development in electronic systems used by people. In recent mobile communication systems, i.e., multimedia electronic instruments such as a portable multimedia player (PMP) or handheld phone (HHP), or personal digital assistant (PDA) etc., a multiprocessor system employing a plurality of processors within one system to get a high speed and smooth operation in function or operation is relatively more desirable. For example, in handheld phones, in addition to basic telephone function, functions of, for example, music, game, camera, payment, moving picture etc., may be implemented according to a convergence requirement of users. Therefore, it may be advantageous to adapt a communication processor and an application processor, together, on a printed circuit board (PCB) within the handheld phone, the communication processor performing a communication modulation/demodulation function and the application processor performing an application function except the communication function.

In such multiprocessor systems, a semiconductor memory employed to store process data may be diversely changed in operation or functional aspect. For example, a plurality of access ports are employed and it may be required to simultaneously input/output data through the plurality of access ports.

In general, a semiconductor memory device having two access ports is called a dual-port memory. A typical dual-port memory has been known in the field as an image processing video memory having a RAM port accessible in a random sequence and a SAM port accessible just in a serial sequence. Unlike the configuration of the video memory mentioned above, a dynamic random access memory (DRAM) which does not employ an SAM port and for which a shared memory area of a memory cell array formed of DRAM cells is accessible by respective processors through a plurality of access ports, is called herein a multiport semiconductor memory device or multipath accessible semiconductor memory device to distinguish this memory from the dual-port memory.

FIG. 1 illustrates a related technology to access a shared memory area through a plurality of processors.

Referring to FIG. 1 illustrating a block diagram of a multiprocessor system according to a related art, a memory array 35 comprises first, second and third portions. In the multiprocessor system 150, the first portion 33 of the memory array 35 is accessed just by a first processor 170 through a port 37 via line 175, and the second portion 31 is accessed just by a second processor 80 through a port 38 via line 85, and the third portion 32 is accessed by all of the first and second processors 170 and 80. The size of the first and second portions 33 and 31 in the memory array 35 may be changed flexibly depending on an operation load of the first and second processors 170 and 80, and the memory array 35 is realized herein as a memory type or disk storage type.

To realize the third portion 32 shared by first and second processors 170 and 80 within the memory array 35 in a DRAM structure, several subjects should be settled. One of the subjects is to appropriately control a read/write path control technique to respective ports and a disposition of memory areas within one memory array 35.

In a multiprocessor system employing a nonvolatile memory and a multiport semiconductor memory device it is desirable to substantially reduce development resources of, i.e., software etc., and simplify the configuration of system in the configuration of shared memory.

### SUMMARY

Accordingly, some embodiments provide a nonvolatile semiconductor memory device of a multichip package type having a shared bus, and a multiprocessor system having a multiport semiconductor memory device.

One embodiment includes a multiprocessor system employing a nonvolatile semiconductor memory device of a multichip package type accessed dedicatedly by respective processors through a shared bus. A data access collision between processors can be prevented when nonvolatile memory areas are adapted in a multichip package type and accessed by processors through the shared bus.

Another embodiment includes provides a multiprocessor system and an access method of a nonvolatile semiconductor memory thereof to simplify a configuration of system through an improved configuration and structure of memories accessed by processors.

Yet another embodiment includes a multiport semiconductor memory device with an independent access function using a shared bus in a sharing structure of nonvolatile memory, and a multiprocessor system employing the same.

According to one embodiment, a multiprocessor system comprises a first processor; a second processor; a semiconductor memory device including a shared memory area accessed in common by the first and second processors through different ports and assigned within a memory cell array, and an internal register positioned outside the memory cell array, the internal register being adapted to provide an access authority for the shared bus to the first and second processors; and a nonvolatile semiconductor memory device including first and second nonvolatile memory areas coupled corresponding to the first and second processors through the shared bus, the first and second nonvolatile memory areas being accessed by and corresponding to the first and second processors according to the access authority for the shared bus.

The nonvolatile semiconductor memory device may be a flash memory, and in this case, the flash memory may be a NAND type flash memory having a NAND type memory cell structure.

The shared memory area is assigned in a unit of a memory bank, and the memory cell array may further comprise dedicated memory areas accessed dedicatedly by the respective processors.

The internal register may comprise semaphore areas storing access authority information to the shared bus, and mailbox areas storing a message of request related to the access authority or a change execution thereof.

The first and second nonvolatile memory areas may be formed in a multichip package type, and the internal register may be accessed in place of a specific area of the shared memory area in response to a specific address for the shared memory area.

A chip enable for the first and second nonvolatile memory areas may be performed independently by the individually corresponding first and second processors. Besides the semaphore areas and the mailbox areas, the internal register may further comprise mailbox areas and semaphore areas to access the shared memory area.

The second processor, the semiconductor memory device and the nonvolatile semiconductor memory device constitute a memory link architecture.

According to another embodiment, a multiprocessor system comprises at least two processors individually performing a predetermined task; a semiconductor memory device including a shared memory area accessed in common by the processors through different ports and assigned within a memory cell array, and an internal register positioned outside the memory cell array, the internal register being adapted to provide an access authority for a shared bus to the processors; and a nonvolatile semiconductor memory device including nonvolatile memory areas individually coupled corresponding to the processors through the shared bus, the nonvolatile memory areas being adapted to store boot codes of the processors and being accessed by and corresponding to the processors according to an access authority for the shared bus.

In the nonvolatile semiconductor memory device, the nonvolatile memory areas may be adapted in a multichip package type, and the processors may comprise a MODEM processor and an application processor.

A chip enable for the nonvolatile memory areas may be performed independently by the respective corresponding processors. The nonvolatile semiconductor memory device may be coupled to the shared bus through balls adapted within a ball grid array in a multichip package.

The multiprocessor system may be one of mobile phone, PMP, portable gaming device, PDA and portable phone.

According to another embodiment, a semiconductor memory device comprises a shared memory area accessed in common by processors through different ports and assigned in a memory cell array; dedicated memory areas assigned in the memory cell array and dedicatedly accessed by the respective processors; and an internal register positioned outside the memory cell array, the internal register being for providing an access authority for a shared bus of a flash memory of a multichip package type to the processors.

According to yet another embodiment, a method of accessing a nonvolatile semiconductor memory device by first and second processors coupled to each other through a volatile semiconductor memory device for a communication interface, the nonvolatile semiconductor memory device having a multichip package type and including first and second nonvolatile memory areas coupled in common to a shared bus, comprises preparing a shared memory area accessed in common by the first and second processors through different ports within a memory cell array of the nonvolatile semiconductor memory device, and an internal register positioned outside the memory cell array and accessed in place of a specific area in response to an address indicating an access authority for the shared bus and indicating the specific area of the shared memory area, reading access authority information of the internal register when the first processor accesses the first nonvolatile memory area, and then accessing the first nonvolatile memory area through the shared bus when having an access authority, and writing access request information to the internal register when not having the access authority; and reading access authority information of the internal register when the second processor accesses the second nonvolatile memory area, and then accessing the second nonvolatile memory area through the shared bus when having the access authority, and writing access request information to the internal register when not having the access authority.

The access authority information may be stored by using a semaphore area of the internal register, and the access request information may be stored by using a mailbox area of the internal register.

The multiprocessor system may be one of vehicle mobile phone, PMP, portable gaming device, PDA and portable phone. The nonvolatile memory may be a memory of EEPROM system, flash memory, or phase-change RAM (PRAM).

A nonvolatile semiconductor memory device of a multichip package type dedicatedly accessed by respective processors through a shared bus can be employed within a multiprocessor system, accordingly a change of software does not required as compared with a single chip package type, and the number of balls in a ball grid array of a multichip package is reduced and a structure of the system is simplified.

In addition, in accessing a nonvolatile semiconductor memory device, an internal register of a volatile semiconductor memory device is used by processors, thereby preventing a data access collision between the processors. Chips of a nonvolatile memory device are independently enabled and operate, thereby increasing a security of the system.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a block diagram schematically illustrating a multiprocessor system according to related art;

FIG. 2 is a block diagram schematically illustrating a memory connection structure of an improved multiprocessor system according to related art;

FIG. 3 is a block diagram of multiprocessor system with a shared bus structure according to an embodiment;

FIG. 4 is a block diagram for a function in an access operation of shared bus in a multiprocessor system referred to in FIG. 3;

FIG. 5 is a block diagram illustrating in detail a multiport semiconductor memory device referred to in FIG. 3;

FIG. 6 provides address assignment and substitutive access relation of an internal register and memory banks referred to in FIG. 5;

FIG. 7 is a circuit diagram illustrating in detail an example of multipath access to a shared memory area referred to in FIG. 5;

FIG. 8 illustrates an example of connection between a first port unit and a first path unit referred to in FIG. 5;

FIG. 9 is a block diagram illustrating in detail a nonvolatile semiconductor memory device referred to in FIG. 3;

FIG. 10 illustrates a structure of unit memory cell constituting a memory cell array shown in FIG. 9; and

FIG. 11 illustrates an example of NAND type memory cell array with a string type layout of unit memory cells shown in FIG. 10.

### DETAILED DESCRIPTION OF THE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

A multiprocessor system employing a multiport semiconductor memory device and a nonvolatile memory having a shared bus will be described as follows, according to embodiments.

A multiprocessor system according to related art is first described as follows, for a thorough understanding of the example embodiments.

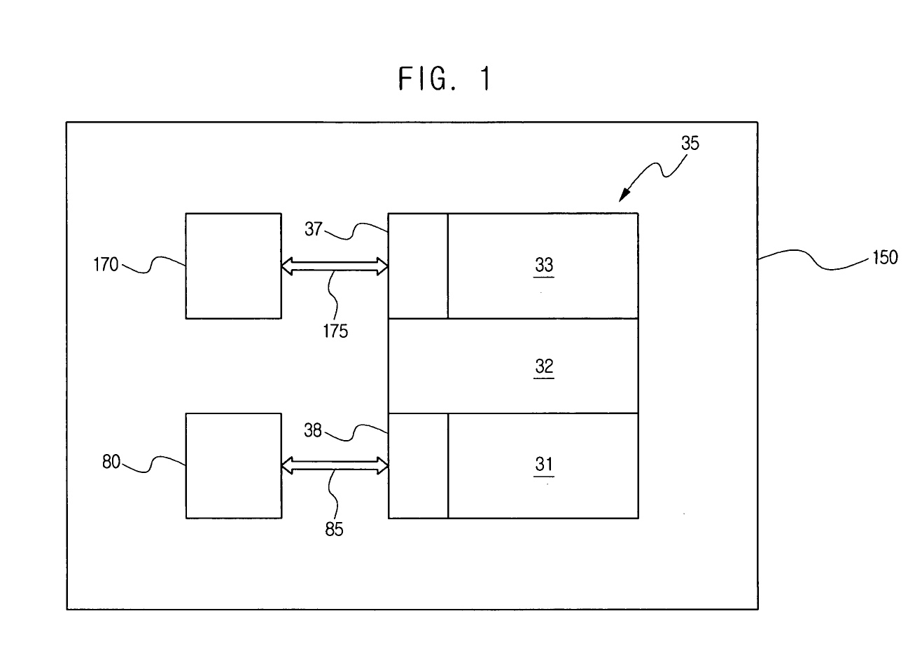

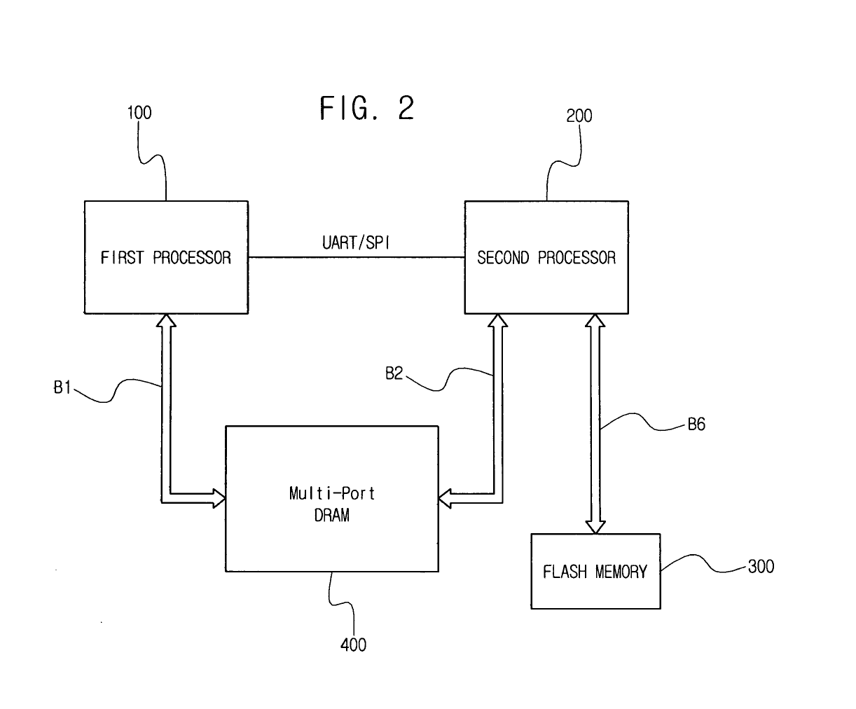

A multiprocessor system of related art in FIG. 2 may have a contrast configuration to the related art of FIG. 1 to constitute a multimedia device etc.

FIG. 2 is a block diagram schematically illustrating a memory connection structure of a multiprocessor system having a system structure comprising two processors 100 and 200, one DRAM 400 and one flash memory 300.

Describing more in detail, a multiprocessor system adaptable to a mobile communication device, i.e., handheld phones, according to a related art, basically comprises a multiport semiconductor memory device 400 (oneDRAM). First and second processors 100 and 200 employed in the multiprocessor system share the DRAM 400 having a multiport. Furthermore, a flash memory 300 is coupled to the second processor 200 through a bus line B6 and thus the first processor 100 can indirectly access the flash memory 300 through the oneDRAM 400 and the second processor 200. On the other hand, the second processor 200 directly accesses the flash memory 300.

In the memory connection structure of FIG. 2, it may be difficult for the first processor 100 to directly access the flash memory 300. For example, if another flash memory is coupled to the first processor 100, the direct access is valid, but this is not effective from the viewpoint to simplify the entire system and reduce cost. Accordingly, the first processor 100 communicates with the second processor 200 through a host interface, i.e., UART/SPI interface etc., and thus reads data stored in the flash memory 300 through the oneDRAM 400 or writes data to the flash memory 300.

In the following description, the first processor 100 performs a booting operation by indirectly accessing the flash memory 300 in an early operation of the system and stores updated-communication codes in the flash memory 300.

Describing more in detail, in a flashless booting of the MODEM processor 100 according to a related art, the application processor 200 reads a code for a DRAM controller setting from the flash memory 300, and then sends the code to the MODEM processor 100 through an UART as a serial interface between hosts. On the other hand, the application processor 200 reads an OS for a MODEM processor from the flash memory 300 and then writes it to the oneDRAM 400 as the multiport semiconductor memory device. That is, the MODEM processor 100 performs a booting by reading the code applied through the UART and the OS for the MODEM processor 100 written to the oneDRAM.

Furthermore, the MODEM processor 100 first writes a communication code to the oneDRAM 400 to store a communication code updated during operating in the flash memory 300 after booting, and transmits a message for writing to the application processor 200.

Then, the application processor 200 reads the written-communication code from the oneDRAM 400 and writes to a code storage area of the flash memory 300.

Accordingly, such multiprocessor system referred to in FIG. 2 has the structure that the MODEM processor 100 indirectly accesses the flash memory 300 with help of the application processor 200, thus a direct access of the MODEM processor is relatively very difficult, a file system and software having a particular protocol may have to be changed substantially, and many development resources may be required. Furthermore, data transmission speed is slow and current consumption in the application processor 200 increases.

On the other hand, when adapting a specific dedicated flash memory in a MODEM processor to deviate from flashless, the system structure becomes complicated and a cost for the system increases.

Therefore, a substantial reduction of a development resource in software etc. based on a shared structure of memory, and a simplification of system configuration, are inevitably desired.

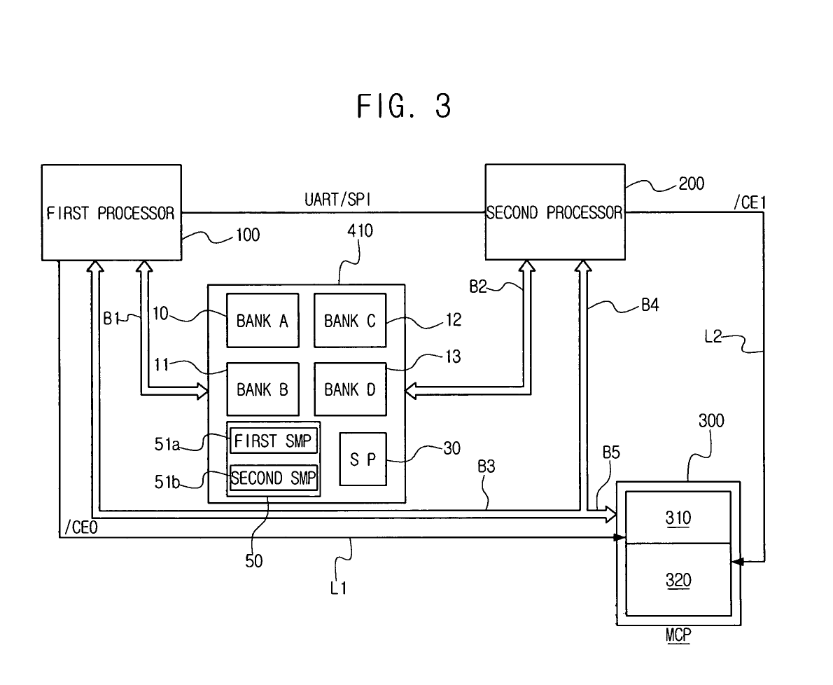

FIG. 3 is a block diagram of multiprocessor system with a shared bus structure according to an embodiment.

Referring to FIG. 3, a bus line B3 is adapted between first processor 100 and a nonvolatile memory device, i.e., flash memory 300, unlike the connection structure of FIG. 2. The bus line B3 and a bus line B4 of the second processor 200 are all coupled to a shared bus B5.

The flash memory 300 comprises in a multichip package type, a first nonvolatile memory area 310 dedicatedly accessed by the first processor 100, and a second nonvolatile memory area 320 dedicatedly accessed by the second processor 200. A firmware F/W and data, appropriated to each corresponding processor, respectively, are stored in the first and second nonvolatile memory areas 310 and 320. As a result, the flash memory 300 shown in FIG. 3 is formed in a multichip package (MCP) type, and the first nonvolatile memory area 310 implemented as one independent chip is dedicatedly accessed by the first processor 100, and the second nonvolatile memory area 320 realized as another independent chip is dedicatedly accessed by the second processor 200. A ball grid array may be formed outside the multichip package. To provide a relatively more compact system structure by reducing the number of adapted-balls, the first and second nonvolatile memory areas 310 and 320 use the shared bus B5. The shared bus 135 is provided as lines to transmit input/output data and control signals.

When the first processor 100 has an authority to use the shared bus B5, the first processor 100 activates a first chip enable signal /CE0 and then applies it to a chip enable pin of the first nonvolatile memory area 310 through line L1. When the second processor 200 has an authority to access the shared bus B5, the second processor 200 activates a second chip enable signal /CE1 and then applies it to a chip enable pin of the second nonvolatile memory area 320 through line L2.

An internal register 50 providing an access authority for the shared bus B5 is adapted outside a memory cell array that is adapted within a multiport semiconductor memory device as a volatile memory, i.e., DRAM 410, such that the first and second processors 100 and 200 can obtain an authority to access the shared bus B5 without a collision. For example, when a second semaphore area 51b of the internal register 50 has information to access the first nonvolatile memory area 310 by the first processor 100 through the shared bus B5, the first processor 100 activates the first chip enable signal /CE0, and thus can access the first nonvolatile memory area 310. On the other hand, when the second semaphore area 51b of the internal register 50 has information to access the second nonvolatile memory area 320 by the second processor 200 through the shared bus 135, the second processor 200 activates the second chip enable signal /CE1, and thus can access the second nonvolatile memory area 320. DRAM 410 may be, for example, a oneDRAM type memory.

Access authority information for the shared bus is stored in the second semaphore area 51b of the internal register 50 of the DRAM 410, and the access authority information for a shared memory area 11 predetermined as the bank B is stored in the first semaphore area 51a. Accordingly, in one embodiment, a nonvolatile semiconductor memory device is configured in a multichip package type, and an access arbitration for the shared bus of the nonvolatile semiconductor memory device is realized by utilizing an internal register of the DRAM 410.

Referring back to FIG. 3, within the multiport semiconductor memory device, DRAM 410, coupled to respectively corresponding processors 100 and 200 through system buses B1 and B2, when memory banks constituting a memory cell array are designed as four, a bank A 10 functioning as a first dedicated memory area may be configured to be accessed dedicatedly by a first processor 100, and banks C 12 and D 13, functioning as second dedicated memory areas may be configured to be accessed dedicatedly by a second processor 200.

On the other hand, bank B 11 as the shared memory area has a connection structure of being accessed by both of the first and second processors 100 and 200. That is, the bank B 11 within the memory cell array is assigned as the shared memory area.

The dedicated memory areas 10, 12 and 13 and the shared memory area 11 may all be comprised of DRAM cells, each cell comprising one access transistor and one storage capacitor. The DRAM cells have a refresh operation to preserve a storage charge of cell.

Here the four memory areas 10, 11, 12 and 13 may be individually configured as a bank unit of DRAM, and one bank may have a memory storage of, for example, 16 Mb (Megabit), 32 Mb, 64 Mb, 128 Mb, 256 Mb, 512 Mb or 1024 Mb.

The internal register 50 of the multiport DRAM 410 may also function as a path controller. The internal register 50 controls a switching unit 30, that is, through a control operation of the internal register 50, the second bank 11 is coupled to the system bus B1 when the first processor 100 accesses the second bank 11, and the second bank 11 is coupled to the system bus B2 when the second processor 200 accesses the second bank 11.

When the first processor 100 has the access authority by referring to the second semaphore area 51b of the internal register 50 and even when the second processor 200 has a sleep mode, the first processor 100 can read or write data by accessing the first nonvolatile memory area 310 through the shared bus B5.

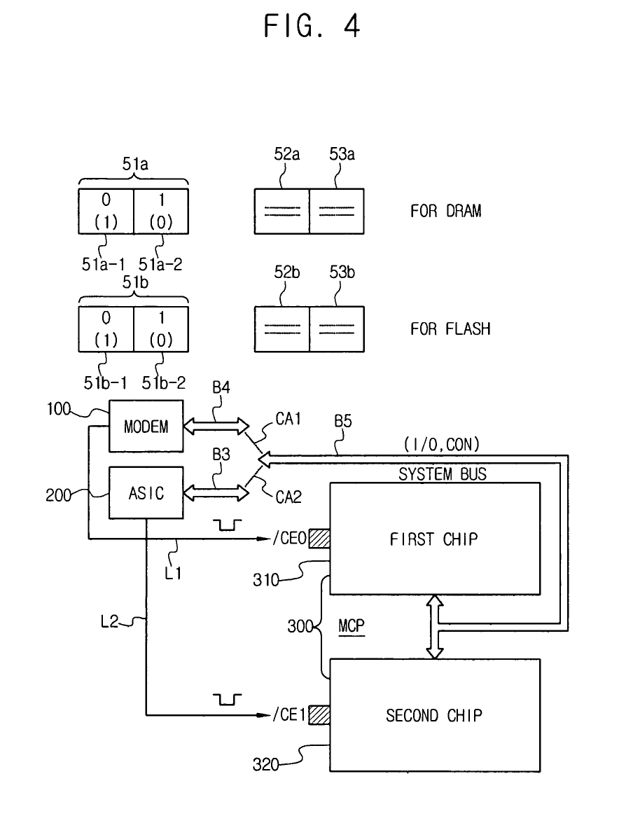

FIG. 4 is a block diagram for a function in an access operation of a shared bus in a multiprocessor system referred to in FIG. 3.

FIG. 4 illustrates a first semaphore area 51a and a second semaphore area 51b of FIG. 3, and first and second nonvolatile memory areas 310 and 320 of the flash memory 300 of which an access area is decided according to information stored in the second semaphore area 51b. For example, when data “01” is stored in information storage areas 51b-1 and 51b-2 of the second semaphore area 51b having a storage of information concerning an access authority to the shared bus B5 of the flash memory 300, the second processor 200 has an access authority to access the area 320 of the flash memory 300. Furthermore, it may be determined that when data “10” is stored in information storage areas 51b-1 and 51b-2 of the second semaphore area 51b, the first processor 100 has an authority to access the area 310 of the flash memory 30. Accordingly, in the information storage areas 51b-1 and 51b-2, the information storage area 51b-1 is written by the first processor 100, and the information storage area 51b-2 is written by the second processor 200. When the second processor 200 changes data of the information storage area 51b-2 from “1” to “0” and a given period of time lapses, data of the information storage area 51b-1 is automatically changed from “0” to “1”. Additionally, when the first processor 100 changes data of the information storage area 51b-1 from “1” to “0” and also a given time lapses, data of the information storage area 51b-2 is automatically changed to “1”.

In DRAM mailbox areas 52a and 53a, a message i.e., data to inform an authority change or authority request for an access of the shared memory area of the DRAM 410, to be transmitted between the first and second processors 100 and 200, is written. That is, in the mailbox area 52a, a message transmitted from the first processor 100 to the second processor 200 is written, and in the mailbox area 53a, a message transmitted from the second processor 200 to the first processor 100 is written. Processor 100 may be a MODEM processor and processor 200 may be an ASIC processor.

In second flash areas 52b and 53b, a message i.e., data to inform an authority change or authority request for an access of the shared bus, to be transmitted between the first and second processors 100 and 200, is written. That is, in the mailbox area 52b, a message transmitted from the first processor 100 to the second processor 200 is written, and in the mailbox area 53b, a message transmitted from the second processor 200 to the first processor 100 is written. Processor 100 may be a MODEM processor and processor 200 may be an ASIC processor.

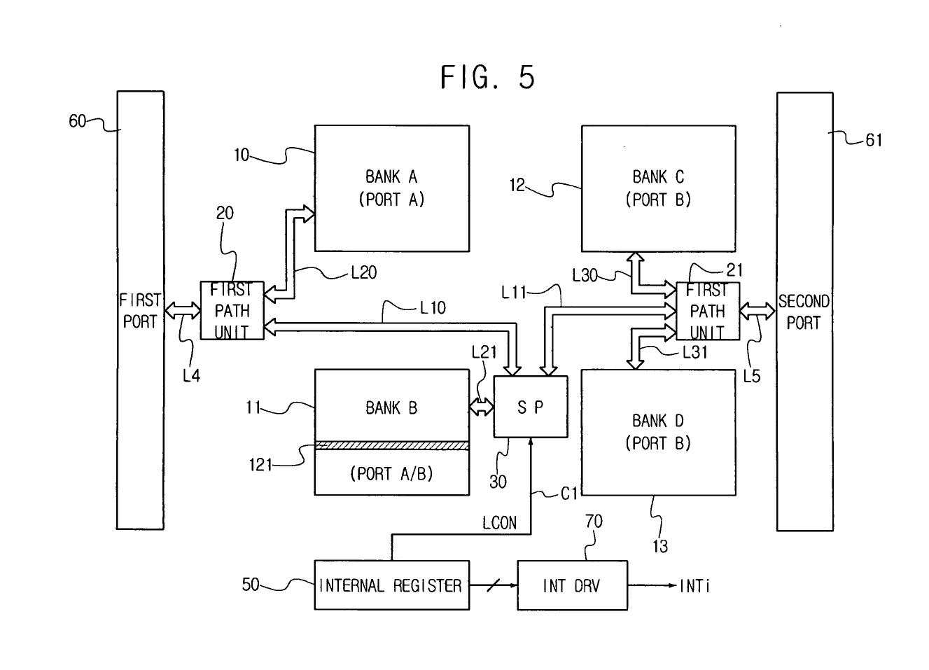

FIG. 5 is a block diagram illustrating in detail a multiport semiconductor memory device referred to in FIG. 3.

First and second ports 60 and 61 shown in FIG. 5 constitute port units. The port units are coupled to respective corresponding processors 100 and 200.

The shared memory area 11 as the bank B is accessed in common by the processors through the port units and is assigned with a predetermined memory capacity unit to a portion of memory cell array.

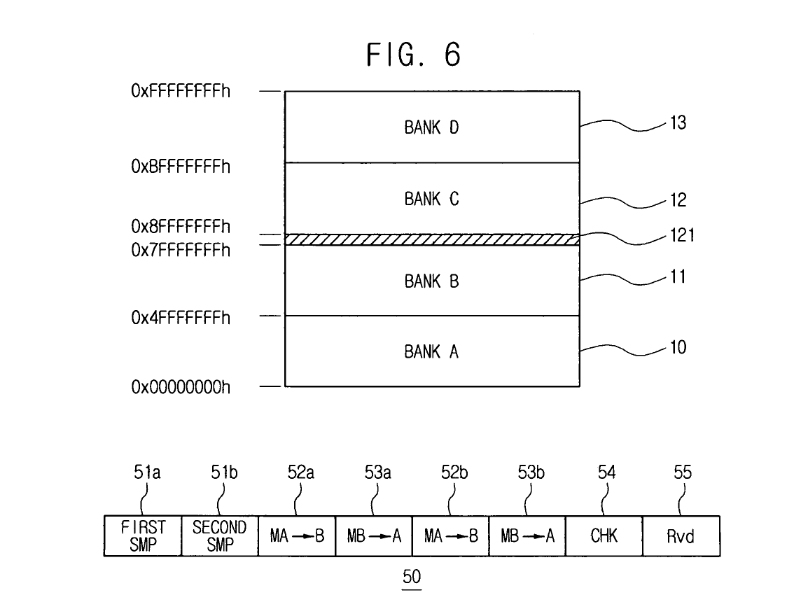

The internal register 50 functioning as a path control unit controls a data path between the shared memory area 11 and the port units 60 and 61 through a switching unit 30 to get a data transmission/reception between the processors 100 and 200 through the shared memory area 11. As shown in FIG. 6, the second semaphore area 51b positioned outside the memory cell array and storing therein information for an access authority of the flash memory 300, is included in a portion of the internal register 50 referred to in FIG. 5.

As a result, the internal register 50 is accessed in place of a specific area of the shared memory area 11 outside the memory cell array, when a specific address is applied to access the specific area 121 of the shared memory area 11.

A switching unit 30 is coupled to the internal register 50 as the path control unit, and according to a switching control signal LCON applied through a control line C1, the shared memory area 11 is operationally coupled to the first path unit 20 or second path unit 21.

That is, when the first processor 100 coupled to a first port 60 accesses the shared memory area 11, lines L4, L10 and L21 adapted among the first path unit 20, switching unit 30 and shared memory area 11 are operationally coupled with one another.

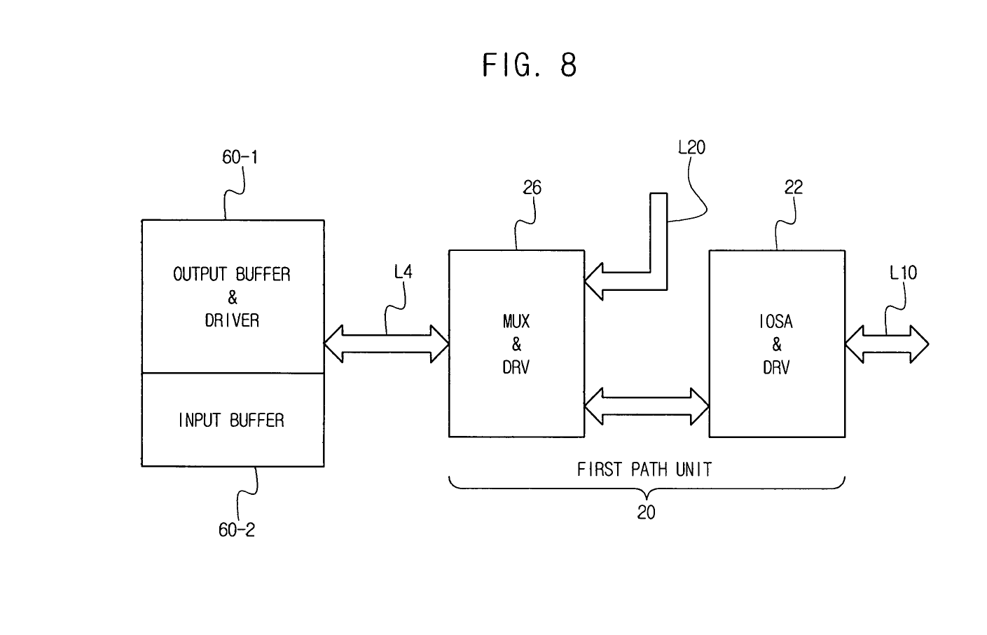

In FIG. 5, the first path unit 20 has a basic function of switching a line L4 to one of input/output lines L10 and L20, and may be comprised of an input/output sense amplifier and driver 22 and a multiplexer and driver 26 as shown in FIG. 8. Similarly, the second path unit 21 has a basic function of switching a line L5 to one of input/output lines L30, L11 and L31, and may be comprised of input/output sense amplifier and driver 22 and multiplexer and driver 26 as shown in FIG. 8.

An interrupt driver 70 may be coupled to the internal register 50 and may be used to apply a processor interrupt signal INTi to respective processors.

In an embodiment, the first processor 100 may have a function of MODEM processor performing a predetermined task, i.e., modulation and demodulation of a communication signal. The second processor 200 may have an application processor function to perform a user convenience function such as a communication data processing or games or amusement etc.

FIG. 6 illustrates an example of address assignment and substitutive access relation of an internal register and memory banks referred to in FIG. 5.

In FIG. 6, if it is assumed that respective banks 10-13 have a capacity of 16 megabits, a specific area of bank B 11 as the shared memory area is determined as a disable area 121. That is, a specific row address (0x7FFFFFFFh˜0x8FFFFFFFh, 2 KB size=1 row size) enabling one optional row of the shared memory area 11 is assigned to access an internal register 50 functioning as a path control and interface unit. Then, when the specific row address (0x7FFFFFFFh 0x8FFFFFFFh) is applied, a corresponding specific word line area 121 of the shared memory area 11 is disabled, but the internal register 50 is enabled. As a result, in an aspect of the system, semaphore areas 51a and 51b and mailbox areas 52a, 53a, 52b and 53b are accessed by using a direct address mapping method, and in an internal aspect, a command approaching to a corresponding disabled address is decoded, thus performing a mapping to an internal register arranged outside the memory cell array. Thus, a memory controller of chip set driven by processors produces a command for this area in the same method as other memory cells.

In FIG. 6, access authority information for the shared memory area 11 and the flash memory 300 is stored in respective first and second semaphore areas 51a and 51b. In DRAM mailbox areas 52a and 53a, a message, i.e., authority request, address, data size, transmission data indicating an address of shared memory having storage data, or commands, etc., to be transmitted between the first and second processors 100 and 200, is written. That is, in the mailbox area 52a, a message transmitted from the first processor 100 to the second processor 200 is written, and in the mailbox area 53a, a message transmitted from the second processor 200 to the first processor 100 is written.

Furthermore, in flash mailbox areas 52b and 53b, a message, i.e., data to inform an authority change or authority request for an access of shared bus, to be transmitted between the first and second processors 100 and 200, is written. That is, in the mailbox area 52b, a message transmitted from the first processor 100 to the second processor 200 is written, and in the mailbox area 53b, a message transmitted from the second processor 200 to the first processor 100 is written.

The semaphore areas 51a and 51b, the DRAM mailbox areas 52a and 53a, flash mailbox areas 52b and 53b may be each assigned with 16 bits, and a check bit area 54 may be assigned with 4 bits. A reserve area 55 may be assigned with 2 bits as a preliminary area.

The areas 51a, 51b, 52a, 52b, 53a, 53b, 54 and 55 may be enabled in common by the specific row address, and may be individually accessed depending on an applied column address.

Consequently, the internal register 50 is a data storage area adapted separately from the memory cell array area for an interface between processors. The internal register 50 is accessed by all of the first and second processors, and may be comprised of a flip-flop and a data latch. That is, the internal register 50 is comprises a latch type storage cell different from a memory cell of DRAM, thus does not require a refresh operation.

For example, when a data interface between the first and second processors 100 and 200 is obtained through multiport DRAM 410, the first and second processors 100 and 200 can write a message to be transmitted to a corresponding processor by using the mailboxes 52a, 52b, 53a and 53b. A processor of a receiving party having read the written message recognizes the message of the transmission-party processor and performs its corresponding operation.

In the embodiment, data to inform of an authority request for an access of the shared bus or authority change therefor is transmitted to a corresponding processor by using the mailboxes 52b and 53b, and the access authority information is confirmed through the second semaphore 51b, thus the respective processors can access a corresponding nonvolatile memory area without a collision between the processors.

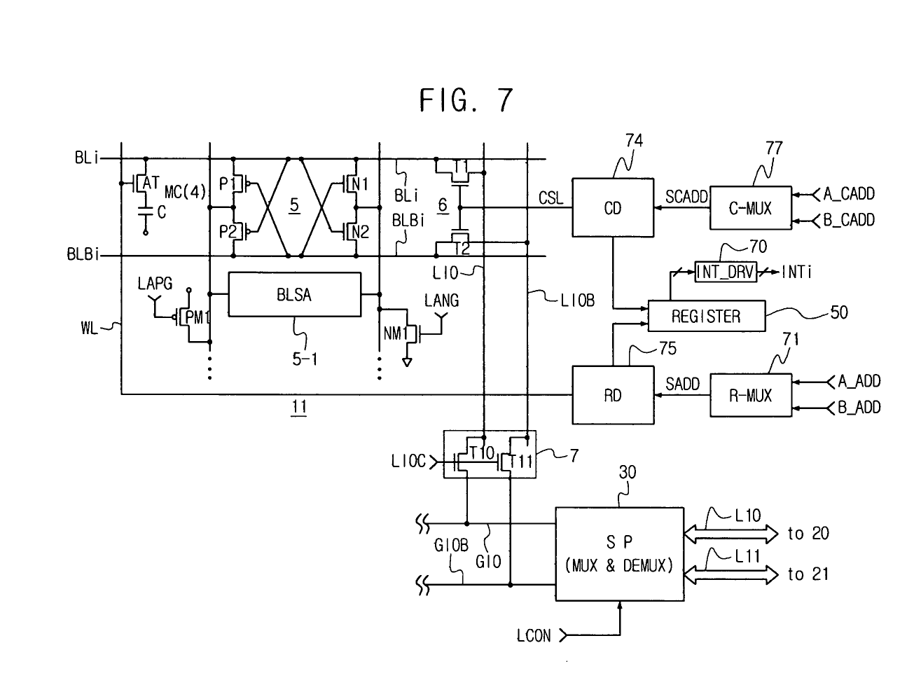

FIG. 7 is a circuit diagram illustrating in detail an example of multipath access to a shared memory area referred to in FIG. 5. FIG. 8 is a block diagram illustrating in detail an example of connection between a first port unit and a first path unit referred to in FIG. 5, in a configuration comprising an input/output sense amplifier and driver 22 and a multiplexer and driver 26.

In FIG. 7, a memory cell MC(4) indicates a memory cell belonging to the shared memory area 11 of FIG. 5. With reference to the drawings, the shared memory area 11 is operationally connected to one of first and second path units 20 and 21 through a switching operation of switching unit 30.

Within the shared memory area 11, the DRAM cell MC(4) comprised of one access transistor AT and a storage capacitor C constitutes a unit memory device. The DRAM cell 4 is connected with intersections of pluralities of word lines WL and pluralities of bit lines BL, thus constituting a bank array of matrix type. A word line WL shown in FIG. 7 is disposed between a gate of access transistor AT of the DRAM cell 4 and a row decoder 75. The row decoder 75 applies a row-decoded signal to the word line and the register unit 50 in response to a selection row address SADD of row address multiplexer 71. A bit line BLi constituting a bit line pair is coupled to a drain of the access transistor AT and a column selection transistor T1. A complementary bit line BLBi is coupled to a column selection transistor T2. PMOS transistors P1 and P2 and NMOS transistors N1 and N2 coupled to the bit line pair BLi and BLBi constitute a bit line sense amplifier 5. Sense amplifier driving transistors PM1 and NM1 receive a drive signals LAPG and LANG, respectively, and drive the bit line sense amplifier 5. A column selection gate 6 comprised of column selection transistors T1 and T2 is coupled to a column selection line CSL transferring a column decoded signal of a column decoder 74. The column decoder 74 applies a column decoded-signal to the column selection line and the register unit 50 in response to a selection column address SCADD of column address multiplexer 77.

In FIG. 7, a local input/output line pair LIO and LIOB is coupled to a first multiplexer 7. When transistors T10 and T11 constituting the first multiplexer 7 are turned on in response to a local input/output line control signal LIOC, the local input/output line pair LIO and LIOB is coupled to a global input/output line pair GIO and GIOB. Then, data of the local input/output line pair LIO and LIOB is transferred to the global input/output line pair GIO and GIOB in a read-operating mode of data. On the other hand, in a write operating mode of data, write data applied to the global input/output line pair GIO and GIOB is transferred to the local input/output line pair LIO and LIOB. The local input/output line control signal LIOC may be a signal generated in response to a decoded signal output from the row decoder 75.

Read data transferred to the global input/output line pair GIO and GIOB is transferred to a corresponding input/output sense amplifier and driver 22 through one of lines L10 and L11 as shown in FIG. 8. The input/output sense amplifier 22 serves as again amplifying data whose level has been weakened according to the transfer steps through several data paths. Read data output from the input/output sense amplifier 22 is transferred to first port 60 through multiplexer and driver 26 that constitutes a first path unit 20 together with the input/output sense amplifier 22 as shown in FIG. 8. When it is the state that the shared memory area 11 is accessed by the first processor 100, the second processor 200 is disconnected from the line L11, thus an access operation of the second processor 200 to the shared memory area 11 is intercepted. But, in this case, the second processor 200 can access the dedicated memory areas 12 and 13 through second port 61.

In write operation, write data applied through the first port 60 is transferred to the global input/output line pair GIO and GIOB of FIG. 7 sequentially through an input buffer 60-2, multiplexer and driver 26, input/output sense amplifier and driver 22 and the switching unit 30 of FIG. 8. When the first multiplexer 7 is activated, the write data is transferred to local input/output line pair LIO and LIOB and is stored in a selected memory cell 4.

An output buffer and driver 60-1 and input buffer 60-2 shown in FIG. 8 may correspond to or be included in the first port 60 of FIG. 5. Further, input/output sense amplifier and driver 22 and multiplexer and driver 26 may correspond to or be included in first path unit 20 of FIG. 5. The multiplexer and driver 26 prevents the shared memory area 11 or dedicated memory area 10 from being simultaneously accessed by one processor.

As described above, in a multiport semiconductor memory device 410 of the embodiment having the detailed configuration as shown in FIG. 7, a DRAM interface function between processors 100 and 200 can be attained since two processors can access in common the shared memory area 11. Furthermore, the processors 100 and 200 can perform a data communication through the commonly accessible shared memory area 11 by using the internal register 50 functioning as a path control and interface unit.

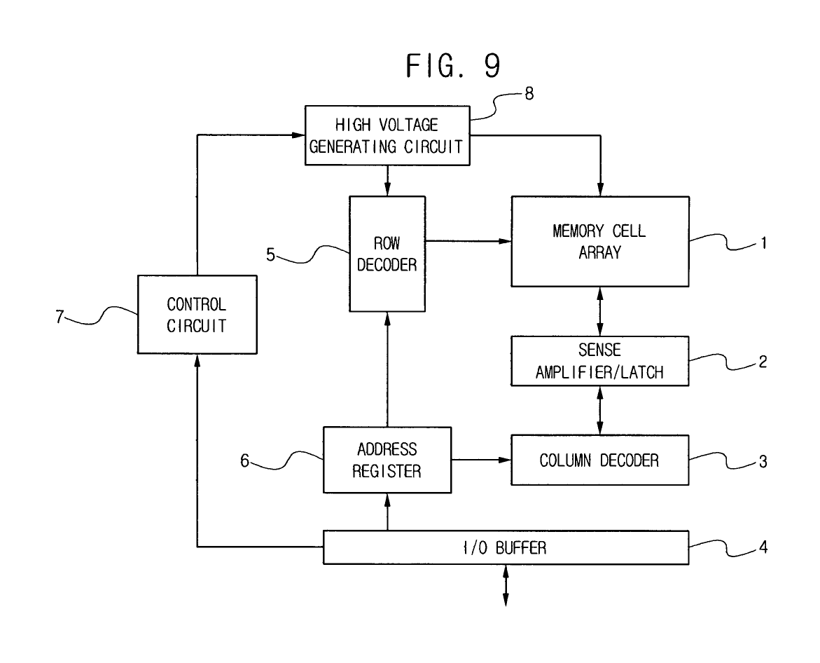

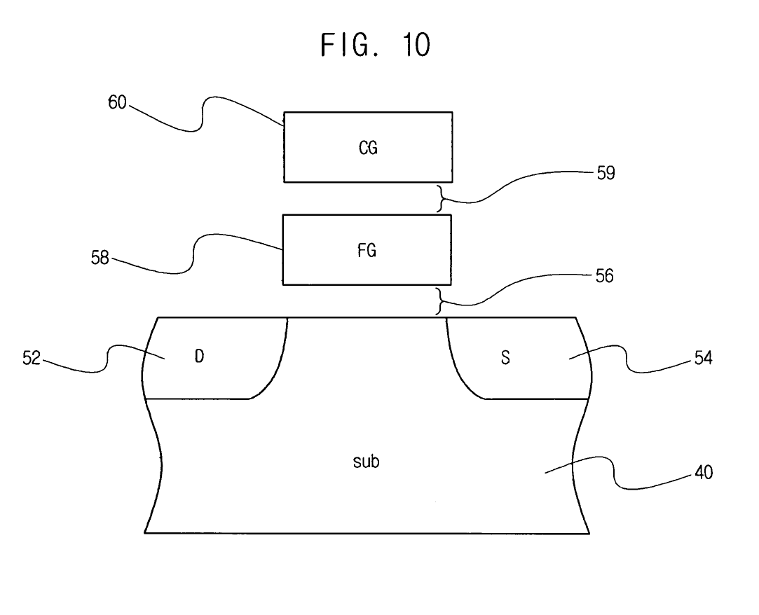

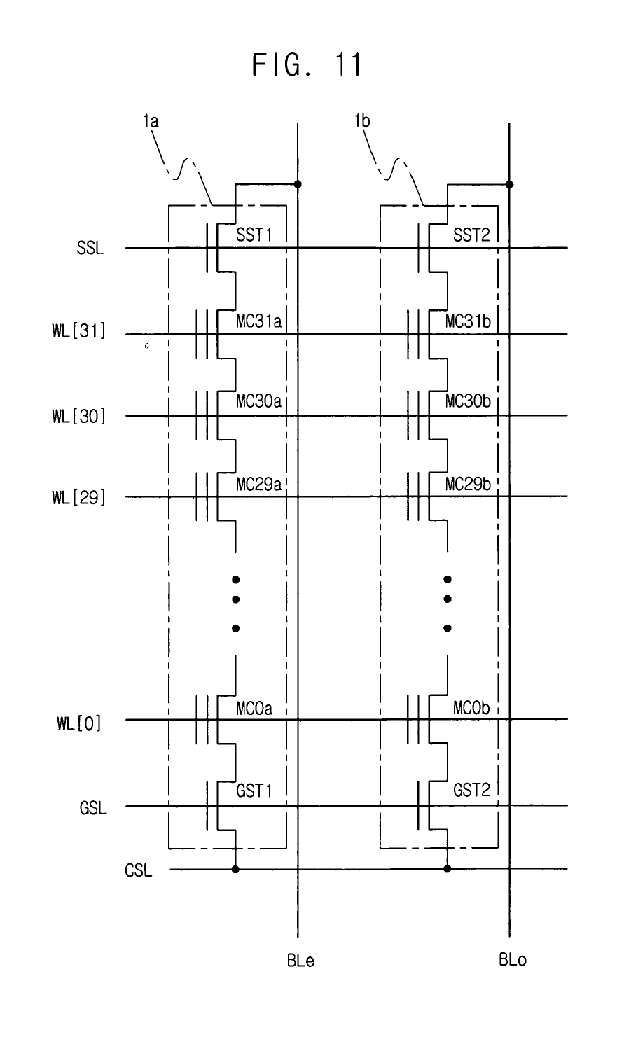

FIG. 9 is a block diagram illustrating in detail a nonvolatile semiconductor memory device referred to in FIG. 3. FIG. 10 illustrates a structure of unit memory cell constituting a memory cell array shown in FIG. 9. FIG. 11 illustrates an example of NAND type memory cell array with a string type layout of unit memory cells shown in FIG. 10.

Device blocks referred to in FIG. 9 are known as a circuit block of a general nonvolatile semiconductor memory device.

FIG. 9 provides a block connection structure of NAND type flash EEPROM including a memory cell array 1, sense amplifier and latch 2, column decoder 3, input/output buffer 4, row decoder 5, address register 6, high voltage generating circuit 8 and control circuit 7. The sense amplifier and latch 2 may sense and store input/output data of memory cell transistors, and the column decoder 3 may select bit lines, and the row decoder 5 may select word lines. The address register 6 may store addresses, and the high voltage generating circuit 8 may generate high voltage higher than operation power voltage for a program or erase operation. The control circuit 7 may provide overall control for an operation of nonvolatile semiconductor memory. Here, the flash memory device having the configuration like in FIG. 9 corresponds to a first nonvolatile memory area 310 of FIG. 3. A second nonvolatile memory area 320 comprises blocks like those in FIG. 9 in another chip, and respective chips are enabled by a specific chip enable pin and have a structure coupled through a shared bus.

The memory cell array 1 may be configured in a NAND type as shown in FIG. 11. That is, FIG. 11 is an equivalent circuit diagram illustrating a connection structure for memory cells of the memory cell array 1. The memory cell array 1 comprises a plurality of cell strings (NAND cell units), but a first cell string 1a coupled to an even bit line BLe and a second cell string 1b coupled to an odd bit line BLo are just shown for a reference in the drawings.

The first cell string 1a comprises a string selection transistor SST1 whose drain is coupled to a bit line BLe, a ground selection transistor GST1 whose source is coupled to a common source line CSL, and a plurality of memory cell transistors MC31a, MC30a, . . . , MC0a whose drain-source channels are connected in series between a source of the string selection transistor SST1 and a drain of the ground selection transistor GST1. Similarly, the second cell string 1b comprises a string selection transistor SST2 whose drain is coupled to a bit line BLo, a ground selection transistor GST2 whose source is coupled to a common source line CSL, and a plurality of memory cell transistors MC31b, MC30b, MC0b whose drain-source channels are connected in series between a source of the string selection transistor SST2 and a drain of the ground selection transistor GST2.

A signal applied to a string selection line SSL is supplied in common to gates of the string selection transistors SST1 and SST2, and a signal applied to a ground selection line GSL is supplied in common to gates of the ground selection transistors GST1 and GST2. Word lines WL0-WL31 are coupled equivalently in common to control gates of memory cell transistors belonging to the same row. Bit lines BLe and BLo operationally coupled to the sense amplifier and latch 2 of FIG. 9 are disposed crossed on a layer different from a layer of the word lines WL0-WL31, the bit lines being disposed in parallel with one another on the same layer.

An optional memory cell transistor shown in FIG. 11 is comprising a MOS transistor having a floating gate 58 in a lower part of the control gate 60 as shown in FIG. 10.

As shown in FIG. 10, operations of unit memory cells formed of MOS transistor having a charge storage floating gate are described as follows.

In operations of a NAND-type EEPROM, erase, write and read operations are described as follows. The erase and program (write) operation can be attained by using an F-N tunneling current. For example, in the erase, a very high potential is applied to a substrate 40 shown in FIG. 10 and a low potential is applied to the CG (Control Gate) 60 of memory cell transistor. In this case, potential decided by a coupling ratio for a capacitance between CG and FG (Floating Gate) 56 and a capacitance between the FG 58 and the substrate 40 is applied to the FG 58. When a potential difference between a floating gate voltage Vfg applied to the FG 58 and a substrate voltage Vsub applied to the substrate 40 is greater than a potential difference creating an F-N tunneling, electrons gathered in the FG 58 move to the substrate 40 from the FG 58. Such operation lowers a threshold voltage Vt of a memory cell transistor comprising CG 60, FG 58, a source 54 and a drain 52. If the Vt is sufficiently lowered so 0 V is applied to the CG 60 and the source 54, and current flows when an appropriate amount of voltage is applied to the drain 52 the memory cell may be determined to be in an “ERASED” state which may be logically represented as ‘1’.

Meanwhile, in the write (program) operation, 0V is applied to source 54 and drain 52 and a very high voltage is applied to CG 60. At this time, an inversion layer is formed in a channel region and the source and drain both have a potential of 0V. When a potential difference between Vfg, which is decided by a rate of capacitances between CG and FG and between FG and the channel region, and Vchannel (0 V) becomes great enough to create the F-N tunneling; electrons move from the channel region to the FG 58. In this case, Vt increases, and if current does not flow when a predetermined amount of voltage is applied to the CG 60, 0V is applied to the source 54 and an appropriate amount of voltage is applied to the drain 52, the memory cell may be determined to be in a “PROGRAMMED” state which may be indicated logically as a logic ‘0’.

In a memory cell array having a plurality of cell strings, i.e., the first and second cell strings, a unit of page indicates memory cell transistors in which control gates are connected in common to the same word line. Plural pages including a plurality of memory cell transistors are provided as a cell block, and one cell block unit generally includes one or plural cell strings per bit line. NAND flash memory has a page program mode for a high speed programming. A page program operation is classified as data loading operation and program operation. The data loading operation includes sequentially loading and storing data of a byte magnitude in data registers from input/output terminals. Data registers are provided to correspond to respective bit lines. The program operation includes writing data stored in the data registers to memory transistors on a selected word line through bit lines.

In the NAND-type EEPROM described above, read operation and program (write) operation are generally performed in a unit of page, and erase operation is performed in a unit of block. Actually, an electron movement between a channel and an FG of the memory cell transistor is performed just in program and erase operations. In read operation, an operation including just reading intact data stored in memory cell transistor without damaging the data, is performed after a completion of the erase and program operation.

In the read operation, a read voltage higher than a selection read voltage Vr applied to CG of a selected memory cell transistor is applied to a CG of non-selected memory cell transistor. Then, current flows or does not flow in a corresponding bit line according to a program state of the selected memory cell transistor. When a threshold voltage of a memory cell programmed under a predetermined voltage condition is higher than a reference value, the memory cell is decided as an off-cell, thus charging a corresponding bit line to voltage of a high level. To the contrary, when a threshold voltage of programmed memory cell is lower than a reference value, the memory cell is decided as an on-cell, and a corresponding bit line is discharged to a low level. This state of the bit line is finally read out as ‘0 ’ or ‘1 ’ through a sense amplifier 2 called the page buffer.

Memory cell transistors of the cell string initially have an erase operation to set a threshold voltage of, for example, about −3V or below. And then, when programming a memory cell transistor, a high voltage is applied to a word line of a selected memory cell for a given time and the selected memory cell is changed into a relatively higher threshold voltage. Threshold voltages of non-selected memory cells in programming are not changed.

An example embodiment is described as follows, referring to the accompanying drawings, without deviating from the spirit of the example embodiments.

As is described in FIGS. 3 and 4, the MODEM processor 100 as a first processor and an ASIC processor 200 as a second processor individually access the first and second chips 310 and 320 of the flash memory 300 and then perform a booting and data read/write operation.

It is systematically determined herein that when a power-on is performed in multiprocessor system with the configuration referred to in FIG. 3, a booting operation of the second processor 200 is first performed. As a result, flag data “1” is set in the semaphore area 51b-2, and the second chip enable signal /CE1 is activated through the line L2. Thus, as shown in the second case CA2 of FIG. 4, the bus line B3 of the second processor 200 is coupled to the shared bus B5 and thus a second chip 320 of the flash memory 300 is accessed independently by the second processor 200. Accordingly, boot code data stored in nonvolatile within the second chip 320 is output through the shared bus B5 and then is loaded into the second processor 200. Then the booting operation of the second processor 200 is completed.

The second processor 200 changes the flag data “1” of the semaphore area 51b-2 shown in FIG. 4 into “0” after the completion of booting operation, and then writes a message to flash mailbox 53b. The message indicates that the access authority to the shared bus has been changed. Thus, the access authority to the shared bus B5 of the flash memory 300 is handed over to the first processor 100. The first processor 100 having read the message of the mailbox 53b after the change of the flag data of semaphore area 51b-2 writes a response message informing of an access authority change completion through the mailbox 52b, when the flag data of the semaphore area 51b-1 corresponding to the first processor (100) itself has been changed to “1”. When the flag data “1” is stored in the semaphore area 51b-1, a first chip enable signal /CE0 is activated through the line L1. Thus, as illustrated in a first case CA1 of FIG. 4, a bus line B4 of the first processor 100 is coupled to the shared bus B5, and thus the first chip 310 of the flash memory 300 is accessed independently by the first processor 100. Accordingly, boot code data stored in nonvolatile in the first chip 310 is output through the shared bus B5 and loaded into the first processor 100, then the booting operation of the first processor 100 is completed.

As described above, the MODEM processor 100 can directly read OS for a MODEM processor by using the first chip 310 without passing through the shared memory area 11, thereby increasing a data transmission speed.

On the other hand, a procedure of storing communication codes updated during operating in the first chip 310 of the flash memory 300 after a booting completion of the MODEM processor 100 will be described as follows. When an application working is completed after the booting, the second processor 200 generally enters a sleep mode to perform a power saving function in a standby state of phone. In this case, immediately before the second processor 200 enters the sleep mode, the second processor 200 keeps writing flag data “0” to the semaphore area 51b. Accordingly, the access authority for the shared bus B5 of the flash memory 300 belongs to the first processor 100. In this case, without waking up the second processor 200, the first processor 100 directly stores the communication code updated during operating in first chip 310 of the flash memory 300. This is a very direct writing in a flash shared-structure. The writing to the flash memory 300 indicates a program operation. The program operation indicates an operation of injecting electrons into a floating gate 58 of FIG. 10, and this has been described above with reference to FIGS. 9 to 11.

On the other hand, in an event occurrence that the second processor 200 accesses the second chip 320 to read or write data, a message of requesting an access authority for the shared bus is written to the flash mailbox 53b. The first processor 100 having read the message changes flag data of the semaphore area 51b-1 from “1” to “0” and writes a response message indicating a transfer of the access authority through the mailbox 52b. Thus, the second processor 200 again has the access authority for the shared bus B5 of the flash memory 300. In this case, the flag data is changed to “1” in the semaphore area 51b-2 and the second chip 320 is enabled. Similarly, as illustrated in the second case CA2 of FIG. 4, bus line B3 of the second processor 200 is coupled to the shared bus B5 and the second chip 320 of the flash memory 300 is accessed independently by the second processor 200. Accordingly, in a write operation, data is stored in nonvolatile within the second chip 320, and in a read operation, storage data is output through the shared bus B5 and provided to the second processor 200.

The direction writing operation described above prevents a current consumption increase of an application processor since the application processor 200 does not wake up.

As described above, a nonvolatile semiconductor memory device of a multichip package type accessed dedicatedly by each processor through a shared bus can be employed in a multiprocessor system. Accordingly a change of software is not required as compared with a single chip package type, and the number of balls within a ball grid array is reduced and a configuration of the system is simplified.

In addition, in accessing a nonvolatile semiconductor memory device, processors utilize an internal register of a volatile semiconductor memory device, thereby preventing a data access collision between the processors, and chips in a nonvolatile semiconductor memory device are enabled independently and operate. Thus reliability for a security of the system is increased.

In a multiprocessor system according to an embodiment, the number of processors may increase to two or more. In the multiprocessor system, the processor may be a microprocessor, CPU, digital signal processor, micro controller, reduced-command set computer, complex command set computer, or the like. It is noted herein that the example embodiments are not limited to a particular number of processors in the system. Further, the example embodiments are not limited to any special combination of processors in adapting the same or different processors as the embodiments described above.

It will be apparent to those skilled in the art that modifications and variations can be made in the example embodiments without deviating from the spirit or scope of the example embodiments. Thus, it is intended that the example embodiments cover any such modifications and variations of the example embodiments provided they come within the scope of the appended claims and their equivalents.

For example, the configuration for a shared memory bank of multiport semiconductor memory, the configuration of semaphore and mailbox in an internal register, or circuit configuration and access method may be diversely changed.

In addition, a control of data path between the shared memory area and the port units can be implemented through various methods. The configuration of semaphore using an internal register has been described above, but without limiting to that, the scope of the example embodiments may be extended to other nonvolatile memories such as PRAM etc.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A multiprocessor system comprising:
a first processor;
a second processor;
a semiconductor memory device including
a memory cell array, a shared memory area configured to be accessed in common by both the first and second processors through different ports, the shared memory area being assigned within the memory cell array, and an internal register positioned outside the memory cell array, the internal register being configured to provide an access authority for a shared bus to the first and second processors; and
a nonvolatile semiconductor memory device including a first and second nonvolatile memory area coupled to the first and second processor, respectively, through the shared bus, the multiprocessor system being configured so that the first and second nonvolatile memory area are accessed by the first and second processor, respectively, according to the access authority for the shared bus.

2. The system of claim 1, wherein the nonvolatile semiconductor memory device is a flash memory.

3. The system of claim 2, wherein the flash memory is a NAND type flash memory having a NAND type memory cell structure.

4. The system of claim 1, wherein the shared memory area is assigned in a unit of a memory bank.

5. The system of claim 4, wherein the memory cell array further comprises dedicated memory areas configured to be accessed dedicatedly by the first and second processors.

6. The system of claim 4, wherein the internal register comprises first semaphore areas and first mail box areas, the first semaphore area storing access authority information for the shared bus, and the first mailbox areas storing a message related to at least one of a request for access authority for the shared bus or a change in the access authority for the shared bus.

7. The system of claim 4, wherein the first and second nonvolatile memory areas are formed in a multichip package type.

8. The system of claim 1, wherein the internal register is configured to be accessed in place of a specific area of the shared memory area in response to a specific address for the shared memory area.

9. The system of claim 7, wherein the first and second processors independently perform a chip enable for the corresponding first and second nonvolatile memory areas.

10. The system of claim 6, wherein the internal register further comprises second mailbox areas and second semaphore areas, the second semaphore area storing access authority information for the shared memory area, and the second mailbox areas storing a message related to at least one of a request for access authority for the shared memory area or a change in the access authority for the shared memory area.

11. The system of claim 1, wherein the second processor, the semiconductor memory device and the nonvolatile semiconductor memory device constitute a memory link architecture.

12. A multiprocessor system comprising:
at least two processors configured to individually perform respective tasks;
a semiconductor memory device including a memory cell array and an internal register, the memory cell array including a shared memory area configured to be accessed in common by the processors through different ports, the shared memory area being assigned within the memory cell array, and the internal register positioned outside the memory cell array, the internal register being configured to provide an access authority for a shared bus to the processors; and
a nonvolatile semiconductor memory device, which includes nonvolatile memory areas each individually coupled to corresponding areas of the processors, through the shared bus, the nonvolatile memory areas being configured to store boot codes of the processors, each nonvolatile memory area being configured to be accessed by the corresponding processor according to the access authority for the shared bus.

13. The system of claim 12, wherein the nonvolatile memory areas are configured in a multichip package type in the nonvolatile semiconductor memory device.

14. The system of claim 12, wherein the processors include a MODEM processor and an application processor.

15. The system of claim 12, wherein a chip enable for the nonvolatile memory areas is performed independently by the corresponding at least two processors.

16. The system of claim 12, wherein the nonvolatile semiconductor memory device is coupled to the shared bus through balls configured within a ball grid array in the multichip package.

17. The system of claim 12, wherein the multiprocessor system is one of mobile phone, portable media player (PMP), portable gaming device, personal digital assistant (PDA) and portable phone.

18. A semiconductor memory device, comprising:
a shared memory area configured to be accessed in common by a plurality of processors through different ports, the shared memory area being assigned in a memory cell array;
dedicated memory areas assigned in the memory cell array, the dedicated memory areas being configured to be dedicatedly accessed by corresponding processors, from among the plurality of processors; and
an internal register positioned outside the memory cell array, the internal register being configured to provide an access authority for a shared bus of a flash memory of a multichip package type to the plurality processors.

19. A method of accessing a nonvolatile semiconductor memory device by first and second processors coupled to each other through a volatile semiconductor memory device for a communication interface, the nonvolatile semiconductor memory device having a multichip package type and including first and second nonvolatile memory areas coupled in common to a shared bus, the method comprising:
reading access authority information of an internal register when the first processor accesses the first nonvolatile memory area, the internal register being positioned outside a memory cell array of the volatile semiconductor memory device and accessed in place of a specific area in response to an address indicating an access authority for the shared bus and indicating the specific area of the shared memory area;
accessing the first nonvolatile memory area through the shared bus when having an access authority for the first processor;
writing access request information to the internal register when not having the access authority for the first processor;
reading access authority information of the internal register when the second processor accesses the second nonvolatile memory area;
accessing the second nonvolatile memory area through the shared bus when having an access authority for the second processor; and
writing access request information to the internal register when not having the access authority for the second processor, the volatile semiconductor memory device including a shared memory area accessed in common by the first and second processors through different ports within a memory cell array of the volatile semiconductor memory device.

20. The method of claim 19, wherein the access authority information is stored by using a semaphore area of the internal register, and the access request information is stored by using a mailbox area of the internal register.
